(19) United States
(12) Patent Application Publication
(10) Pub. No.: US 2018/0036184 A1
(43) Pub. Date: Feb. 8, 2018

(54) STRETCHER

(71) Applicant: SYKEHUSET TELEMARK HF, Skien (NO)

(72) Inventor: Lorenz Peter,Reuss Christensen, Skien (NO)

(21) Appl. No.: 15/554,281

(22) PCT Filed: Mar. 18, 2016
(86) PCT No.: PCT/EP2016/056058

§ 371 Date: Aug. 29, 2017

(30) Foreign Application Priority Data
Mar. 19, 2015 (GB) 1504679.0

(51) Int. Cl. A61G 1/02; A61G 1/048

(52) U.S. Cl. CPC A61G 1/0212; A61G 1/0262; A61G 1/048; A61G 1/042

(57) ABSTRACT

A stretcher is provided that may include a patient support, a base, a connection member being pivotally connected to the patient support and pivotally connected to the base such that the patient support, the base, and the connection member can form a Z-shape with a first angle at the corner of the Z-shape between the patient support and the connection member and a second angle at the other corner of the Z between the base and the connection member, a first angle adjustment device for controlling the first angle, and a second angle adjustment device for controlling the second angle such that the first angle adjustment device and the second angle adjustment device can be operated independently of each other. A method of loading and unloading a stretcher from an ambulance is also provided.

The invention relates to a stretcher and a method of loading a stretcher into an ambulance.

When treating patients and dealing with medical emergencies, it is common for patients on stretchers to need to be loaded into ambulances. To load a patient on a stretcher into an ambulance, typically the top patient support part of the stretcher is slid, or wheeled, into the back of an ambulance, the undercarriage is then pulled up, either manually or mechanically, to lie immediately under the patient support part and the stretcher with the patient thereon can then be slid, or wheeled, entirely into the back of the ambulance.

The problem with this known stretcher and loading method is that after the undercarriage has been lifted off the ground so that it lies immediately under the patient support part, the personnel loading the patient and stretcher into the ambulance have to support the majority of the weight of the patient and the stretcher which may, for example, be around 150 kg. The same issue arises when unloading the patient from the ambulance as the majority of the weight of the patient and the stretcher has to be supported after the stretcher has been pulled out of the ambulance but before the undercarriage is deployed to support the weight of the patient and the stretcher itself.

It is recommended that a person lift a maximum of 11 kg if the load is close to their body and they are performing the lifting action repeatedly or a maximum of 25 kg if the load is close to their body and they are performing the lifting action only occasionally. A typical paramedic, who may have to load and un-load patients from an ambulance numerous times a day, would far exceed this recommended lifting limit when using the above described known stretcher and loading method.

GB 2427597 discloses a stretcher with a trailing wheel assembly that is arranged so that it can be moved into a position to be in contact with the ground prior to loading the stretcher into an ambulance. This trailing wheel assembly can support the weight of the stretcher and a patient during loading and unloading. As a result, the undercarriage can be raised and the stretcher pushed into an ambulance, without the operator having to support the weight of the stretcher.

This solution, however, requires extra parts to be added to the stretcher which increases its weight. There are stringent requirements in many countries regarding the total weight that ambulances can be, including the weight of items being transported such as the stretcher. Therefore, there is also a desire to be able to address the problem of reducing the loads that paramedics have to lift whilst not increasing, and preferably decreasing, the weight of the stretcher.

In a first aspect, the present invention provides a stretcher, the stretcher comprising: a patient support; a base; a connection member, the connection member being pivotally connected at one end to the patient support and pivotally connected at an opposite end to the base such that the patient support, the base and the connection member can form a Z-shape with a first angle at the corner of the Z-shape between the patient support and the connection member and a second angle at the other corner of the Z between the base and the connection member; a first angle adjustment device for controlling the first angle; and a second angle adjustment device for controlling the second angle, wherein the first angle adjustment device and the second angle adjustment device can be operated independently of each other.

Due to the fact that the stretcher has two independently operable angle adjustment devices the base can be moved into and held in a number of positions relative to the patient support. This permits the stretcher to be loaded into an ambulance without the need for the weight of the stretcher or patient thereon to be supported by a person such as a paramedic. This is because the weight of the stretcher and the patient thereon may be supported by a part of the base whilst the stretcher is being loaded into the ambulance. In other words, the stretcher may be arranged so that the base is movable into a position so that it can at one end be in contact with the floor of the ambulance and at the other opposite end be in contact with the surface from which the stretcher is being loaded (whilst the patient support is kept in a substantially horizontal position).

The stretcher may be a stretcher for use with an ambulance. The stretcher may be a stretcher which is for ambulance transport. The stretcher may be arranged to facilitate the loading and unloading of the stretcher into or from an ambulance.

In a second aspect, the present invention may provide a method of loading a stretcher into an ambulance, the method comprising: providing a stretcher comprising: a patient support; a base; and a connection member, the connection member being pivotally connected to the patient support and pivotally connected to the base such that the patient support, the base and the connection member can form a Z-shape with a first angle at the corner of the Z-shape between the patient support and the connection member and a second angle at the other corner of the Z between the base and the connection member; loading one end of the patient support into the ambulance; adjusting one of the angles so that the base is angled relative to the patient support; loading a first end of the base into the ambulance whilst a second end of the base is in contact with the ground; moving the stretcher further into the ambulance; adjusting the other angle so that the base is substantially parallel to the patient support; and moving the stretcher entirely into the ambulance.

The stretcher may be loaded into the ambulance from the ground and may, at the start of the loading operation be in a position in which the patient support and base are substantially parallel and are located a distance (for example over 50 cm, preferably over 1 m for example between 1 m and 1.5 m) from each other (the below described first position).

In a third aspect, the present invention provides a method of unloading a stretcher from an ambulance, the method comprising: providing a stretcher comprising: a patient support; a base; and a connection member, the connection member being pivotally connected to the patient support and pivotally connected to the base such that the patient support, the base and the connection member can form a Z-shape with a first angle at the corner of the Z-shape between the patient support and the connection member and a second angle at the other corner of the Z between the base and the connection member; moving the stretcher so that it is partially out of the ambulance; adjusting one of the angles so that the base is angled relative to the patient support so that one end of the base is in contact with the ground whilst the other end is in contact with the floor of the ambulance; moving the stretcher further out of the ambulance until the base is no longer in contact with the floor of the ambulance; adjusting the other of the angles so that the base is substantially parallel to the patient support and in contact at each end with the ground; and moving the stretcher entirely out of the ambulance.

The stretcher may be unloaded from the ambulance to the ground and may at the start of the unloading operation be inside the ambulance in a position in which the patient support and base are substantially parallel and are located close (for example less than 10 cm, and about 0 cm apart) to each other (the below described third position).

The methods of the second and third aspects of the invention may comprise use of the stretcher of the first aspect of the invention.

The stretcher may be arranged so that the first angle and second angle can be controlled independently.

The first angle adjustment device may control only the first angle and/or the second angle adjustment device may control only the second angle.

The second angle may not be affected by the operation of the first angle adjustment device and/or the first angle may not be affected by operation of the second angle adjustment device. The stretcher maybe arranged so that the first angle can be adjusted whilst the second angle is not adjusted (i.e. stays at the same angle) and/or the second angle can be adjusted whilst the first angle is not adjusted (i.e. stays at the same angle).

The first angle and the second angle may be adjusted independently of each other.

The stretcher may have a head-end, which is the end the patient's head would be located near when they are lying on the stretcher, and a foot-end, which is the end the patient's feet would be located near when the patient is lying on the stretcher. The patient support and base may thus each have a corresponding head-end and foot-end. The length (which may also be referred to as the longitudinal direction) of the stretcher may be the dimension from the head-end to the foot-end and the width (which may be referred to as the transverse direction) may be the dimension from one side (which extends between the head-end and foot-end of the stretcher) of the stretcher to the other, opposite side of the stretcher.

For example, when loading the stretcher into an ambulance a portion, i.e. head-end or the foot-end, of the patient support may be slid, or wheeled, into the ambulance. Then one of the angle adjustment devices, e.g. the second angle adjustment device, may be operated so that the respective angle is reduced so as to result in one end (the end corresponding to, near or under the end of the patient support that is in the ambulance, e.g. the head-end) of the base being lifted off the floor towards the patient support whilst the other end of the base (e.g. the foot-end) remains on the floor/ground (or location/surface from which the stretcher is being loaded). This results in the base being in a position that is angled relative to the patient support. The raised end of the base may be slid or wheeled into the ambulance whilst the other end of the base, which may be in contact with the surface from which the stretcher is being loaded, provides support for the weight of the stretcher and the patient. The stretcher and patient may then be pushed into the ambulance until at least 50%, and preferably at least 60%, of the weight of the stretcher and patient are in the ambulance. The other of the angle adjustment device (e.g. the first angle adjustment device) may then be operated so that the respective angle is reduced so as to result in the other end of the base (e.g. foot end) being lifted off the surface from which the stretcher is being loaded towards the patient support. The stretcher with the patient thereon may then be pushed entirely into the back of the ambulance. The unloading operation is the opposite of this loading operation.

Due to the fact that 50% or more of the weight of the stretcher (and patient if supported thereon) may be in the ambulance before the base is moved to no longer have a portion in contact with the surface from which the ambulance is being loaded there is no need for personnel loading the stretcher and patient into the ambulance to support the weight of stretcher. This is because in the first part of loading the weight is supported by a portion, or end, of the base that is in contact with the floor and in the second part of loading, once at least 50% of the weight is in the ambulance, the weight is supported by the parts of the stretcher that are in contact with the ambulance floor.

It will be appreciated that the loading process is the same irrespective of whether there is a patient on the stretcher or not (aside from the fact that the point at which at least 50% of the weight is in the ambulance may be different). Therefore, there may not be a patient on the stretcher when it is loaded into the ambulance.

The stretcher may be used to perform an asynchronous lift of the patient into an ambulance. This means that one end of the base can be lifted (whilst the patient support does not move substantially) before the other end of the base is lifted.

The patient support may form the top of the Z shape, the connection member may form the diagonal portion of the Z shape and the base may form the bottom of the Z shape. The base may be the portion of the stretcher that is, in use, in contact with the surface on which the stretcher is being supported or wheeled and the patient support may be the portion of the stretcher on which a patient is, directly or indirectly, supported.

The stretcher may be movable into, and preferably be able to be held in, a number of positions. For example, the positions may include a first position in which the patient support and the base are substantially parallel to each other and separated from each other (to form the Z shape with the connection member). The patient support may be for example over 50 cm, over 1 m or between 1 and 1.5 m from each other for example) In this first position the angles formed by the corners of the Z shape may be equal in magnitude. The angles may each be between 30 and 90 degrees, 35 and 75 degrees, or 40 and 50 degrees.

This first position may be the usual position the stretcher is in when a patient is being wheeled along on the stretcher, i.e. when the base is in contact with the ground and a patient is supported, directly or indirectly, on the patient support. The base and patient support may be substantially parallel to the ground or surface on which the stretcher is being wheeled. The surface from which the stretcher is being loaded may be referred to herein as the ground.

The stretcher may be movable into, and preferably able to be held in, a second position in which the base and patient support are angled relative to each other, for example such that one end of the base is nearer the patient support than the other end of the base. In this position the angle further from the ends of the base and patient support that are closest together may be smaller than the angle closer to the other end in which the base and patient support are furthest from each other. In the second position the larger angle may be between 30 and 90 degrees, 35 and 75 or 40 and 50 degrees and/or the smaller angle may be between −5 and 45 degrees, or 0 and 10 degrees.

This second position may be the position the stretcher is moved to, and held in, when the stretcher is being loaded into or unloaded from an ambulance. The stretcher may be moved into this position once a portion, i.e. end portion, of the patient support is in the ambulance in the case of loading or out of the ambulance in the case of unloading. By moving into this second position the base may be angled relative to the patient support and the ground so that one end of the base can be in contact with the floor of the ambulance whilst the other end is in contact with the surface from which the stretcher is being loaded or to which it is being unloaded.

This second position may also be a position the stretcher is moved to, and held in, when the patient is being supported on the stretcher. In certain cases it may be desirable for the patient support to be angled so that the patient's legs are higher than their head, or vice versa. In this case the patient support may be angled relative to the base by making the angle of the corner that is nearest (in a longitudinal direction rather than height direction) to the part of the patient support that is to be angled away from the base smaller than the angle of the corner that is furthest (in a longitudinal direction) to the part of the patient support that is to be angled towards from the base. This may be achieved by either reducing the angle of the corner that is nearest (in a longitudinal direction rather than height direction) to the part of the patient support that is to be angled away from the base or increasing the angle of the corner that is furthest (in a longitudinal direction) to the part of the patient support that is to be angled towards from the base.

The positions of the stretcher may include a third position in which the patient support and the base are substantially parallel to each other and located close together (for example less than 10 cm or about 0 cm from each other), such as in direct contact with each other. In this position the patient support may be supported by the base. In this third position the angle of the corners may be about zero. For example they may be less than 10 degrees, less than 5 degrees or between 5 and −5 degrees. This may be the position the stretcher when it is loaded in the back of an ambulance.

The stretcher may be moved between the first and third positions without being moved into the second position. This may be achieved by adjusting both the angle adjustment devices simultaneously. By adjusting both of the angles of the corners so that they remain constant relative to each other the distance between the patient support and the base may be adjusted whilst keeping the patient and base parallel to each other. For example the height of the patient support from the ground may be increased by increasing the angles of both the angle adjustment devices and the height of the patient support from the ground may be decreased by decreasing the angles of both the angle adjustment devices.

To load the stretcher into an ambulance the stretcher may be moved from the first position to the second position and then into the third position whilst it is being pushed or pulled into the ambulance.

The stretcher may be moved from the second to the third position once at least 50%, or at least 60%, of the weight of the stretcher and patient thereon is supported in the ambulance. This is so that it is not necessary for any of the weight of the stretcher and patient thereon to be supported by the personnel that is loading the stretcher into the ambulance.

To unload the stretcher from an ambulance the stretcher may be moved from the third position to the second position and then into the first position whilst it is being pulled or pushed out of the ambulance.

The stretcher may be moved from the third to the second position before less than 50%, or less than 60%, of the weight of the stretcher and patient thereon is supported in the ambulance. This is so that it is not necessary for any of the weight of the stretcher and patient thereon to be supported by the personnel that is unloading the stretcher from the ambulance.

The pivotal connection between the connection member and the patient support may be in a fixed position relative to the patient support. For example the connection may not be slidable or movable and may be provided by a pivot between the connection member and the patient support.

The pivotal connection between the connection member and the base may be in a fixed position relative to the base. For example, the connection may not be slidable or movable and may be provided by a pivot between the connection member and the base.

Each pivotal connection may comprise two or more pivot connection points. One pivot connection point of each pivotal connection may be located towards one side of the stretcher and the other pivot connection point maybe located towards the other side of the stretcher.

The connection member may be connected (directly or indirectly) at, or near, one end of the connection member to the patient support and connected (directly or indirectly) at, or near, the other end of the connection member to the base. The connection between the connection member and the patient support may be in a position that is substantially near the middle of the patient support in a longitudinal direction. For example the connection may be at a position that is within the middle 50%, 30%, 25%, 10% of the length of the patient support or at the middle (in a longitudinal direction) of the patient support.

The connection between the connection member and the base may be in a position that is substantially near or at one end of the base. For example the connection may be within 50%, 30%, 25%, 10%, or 5% of the length of the base to the end of the base.

The connection member may be a longitudinally extending frame, such as a substantially rectangular frame that extends between the patient support and the base. The connection may be formed by one or more bars that extend between the base and the frame. For example, one bar may be located so as to extend between the base and patient support at or near one side of the base and patient support (i.e. one side of the stretcher) and another bar may be located so as to extend between the base and patient support at or near the opposite side of the base and patient support (i.e. the other side of the stretcher). These bars may be connected by one or more cross bars that extend between the bars in a direction substantially across the width, i.e. a transverse direction, of the stretcher.

The patient support may be a longitudinally extending frame, such as a substantially rectangular frame. The patient support may have two longitudinally extending bars that extend between the head-end and the foot-end and are substantially parallel to each other. These bars may form the sides of the patient support and may be connected by one or more cross bars that extend across the width of the patient support. The connection member may be pivotally connected at one end to one of these cross bars. The connection member may comprise two bars with one of the bars being pivotally connected to the cross bar towards one side of the stretcher and another of the bars being pivotally connected to the cross bar towards the other side of the stretcher.

The patient support may comprise one or more loading wheels, for example the patient support may comprise a pair of loading wheels. The loading wheel(s) may be located at, or towards, one end of the patient support and may be located on the underside of the patient support. The loading wheel(s) may be provided at only one, or alternatively both ends of the patient support. When loading wheel(s) are provided at or near both ends, the stretcher can be loaded into the ambulance either head-end first or foot-end first.

A cross bar may extend between and connect a pair of loading wheels provided at one end of the patient support. Alternatively and/or additionally, each loading wheel may be supported by an oblique (oblique relative to the patient support) support bar. This may increase the strength of the loading wheels.

The loading wheel(s) may be located at or near the head-end of the patient support and there may be no loading wheels at the foot-end of the patient support. This is because when a patient is on the stretcher the head-end will be heavier than the foot-end and so the stretcher would have to be pushed into the ambulance by a smaller distance to get at least 50% of the weight inside the ambulance when the head-end is pushed into the ambulance first than when the foot-end of the stretcher is pushed into the ambulance first.

When the stretcher is being loaded into the ambulance the loading wheel(s) may be in contact with the floor of the ambulance. The loading wheel(s) may be the part of the stretcher that is in contact with the floor of the ambulance when the first end of the patient support is put into the ambulance. The loading wheel(s) may permit the part of the patient support to be wheeled into the ambulance and/or may facilitate the stretcher being wheeled entirely into the ambulance.

The patient support may comprise a patient bed, or may permit a patient bed to be attached to the patient support, wherein the patient bed is the portion of the stretcher that a patient will lie on in use. The patient bed may be any well-known patient bed such as a bed with an elevatable head part, foot part and/or middle part.

The base may be a longitudinally extending frame, such as a substantially rectangular frame. The base may have two longitudinally extending bars that extend between the head and foot end and are substantially parallel to each other. These bars may form the sides of the base and may be connected by one or more cross bars that extend across the width of the base. The connection member may be pivotally connected at one end to one of these cross bars.

The base may be shaped so that when one end is in contact with the floor of the ambulance and the other end is in contact with the ground from which the stretcher is being loaded, the stretcher can be pushed into the ambulance so that at least 50%, preferably at least 60%, of the weight of the stretcher (and a patient supported thereon, if present) can be inside the ambulance before the back edge of the ambulance floor meets the underside of the base.

For example, the base may have a portion that is raised or angled out of or away from the plane of the wheels of the base. This might be a portion that is raised or angled away from the ground towards the patient support. This raised or angled portion may be towards the end of the base that is first loaded into the ambulance, e.g. the head-end. This raised portion may facilitate the stretcher being loaded into the stretcher as it permits the stretcher to be pushed further into the ambulance before the edge of the ambulance touches the underside of the angled base.

The base may have a length that is shorter than the patient support. The base may have a length that is less than 90%, or less than 80% or about 60% to about 80% of the length of the patient support. This is so when the patient support is angled relative to the base the length of the stretcher (the dimension in the longitudinal direction that is parallel to the ground) can be reduced. This can be advantageous if it is necessary for the stretcher to fit in a small space such as an elevator.

The base may comprise a plurality of base wheels that permit the stretcher to be wheeled such as when it is in the above described first position. The base wheels may be provided on the underside of the base. The base may have one or more base wheels at, or towards, one end (such as the head-end) of the base and may have one or more base wheels at, or towards the other end (such as the foot-end) of the base.

The base wheels may be connected so that they are in a fixed location relative to each other, i.e. the wheels of the base cannot be moved relative to each other.

The stretcher may also comprise one or more support wheels. The support wheel(s) may be wheels that are arranged so as to be in contact with the ground whilst the stretcher is being loaded into an ambulance. The support wheel(s) may be arranged so that they are only in contact with the ground when the base is angled relative to the patient support during loading or unloading of the stretcher.

The support wheel(s) may be located at, or near, one end of the base. This should be the end of the base that supports the stretcher on the ground or surface from which it is being loaded whilst the stretcher is being loaded or unloaded from an ambulance. This support wheel(s) may aid loading as when the base is angled relative to the patient support and one end is received in the back of an ambulance, none of the base wheels may be in contact with the ground, or at least not in a correct orientation to permit the stretcher to be wheeled along the ground. Thus this support wheel(s) may be located so as to permit the end of the base to be wheeled along the ground even when the base is at a substantial angle to the patient support and/or the ground.

The base may also comprise one or more loading wheels. The base loading wheel(s) may be wheels that are arranged to be in contact with the floor of an ambulance during loading and unloading. The base loading wheel(s) may be located on the underside of the base near the angled portion discussed above.

The first and/or second angle adjustment device may be an actuator that is arranged so as to be able to control and hold a certain angle between the patient support and the connection member and between the base and the connection member respectively.

Alternatively the angle adjustment device may be a locking mechanism to lock the angles in certain positions. In this case the angle may be adjusted manually and then locked in place using the angle adjustment device.

The angle adjustment device may for example be a rack and pinion arrangement or a ratchet.

The angle adjustment devices may be an actuator such as a hydraulic actuator, pneumatic actuator or an electrical actuator. The actuators may use pressurised air as a propellant. This arrangement may be particularly advantageous when the ambulance into which the stretcher is being loaded has a supply of pressurised gas.

Each angle adjustment device may be a motor such as an attenuator motor.

The motor may be coaxial with its respective pivotal connection, i.e. the pivotal connection of the angle that the adjustment device controls. For example, if the connection member is connected to a cross bar of the base the motor may be provided around the cross bar such that the connection member can be pivoted relative to the cross bar of the base. If the connection member is connected to a cross bar of the patient support the motor may be provided around the cross bar such that the connection member can be pivoted relative to the cross bar of the patient support.

The first angle adjustment device may be connected at one end to the patient support and may be connected at the other, opposite end to the connection member.

The second angle adjustment device may be connected at one end to the base and may be connected at the other, opposite end to the connection member.

The first angle adjustment device may be connected to the connection member at a location that is closer to the patient support than the location of the connection between the second angle adjustment device and the connection member.

If the patient support, base and/or connection member have the above described cross bars the angle adjustment devices may be connected between two of these cross bars.

The stretcher may comprise one or more handles. These handles may be used to facilitate lifting of the stretcher.

The handles may be movable, for example pivotable, between a stored position and a deployed position. The handles may be arranged so that the handles do not extend past the sides of the stretcher (i.e., they do not increase the width of the stretcher) when in the stored position, when in the deployed position, and when moving between the stored position and the deployed position. This means that the handle(s) can be deployed even when the stretcher is in a narrow space.

The handle(s) may be provided on, e.g. attached to, the patient support. For example, the handle(s) may be attached at, or near, the corners of the patient support.

When in the deployed position the handle(s) may extend away from the end of the stretcher in a direction that is substantially parallel to the length direction of the stretcher. When in the stored position the handle(s) may lie next to the stretcher frame, e.g. the patient support, in a direction that is substantially parallel to the width of the stretcher. For example, the handle(s) may be moved, e.g. pivoted, from their deployed position to the stored position by folding the handles inwards in a direction away from the sides of the stretcher. The handle(s) may be moved, e.g. pivoted, from their stored position to the deployed position by folding the handles outwards in a direction away from the middle of the stretcher.

Thus, in a fourth aspect, the present invention provides a stretcher, the stretcher comprising a handle that is pivotally connected to the stretcher, the handle being movable between a stored position in which the handle is substantially parallel to the end of the stretcher and a deployed position in which the handle extends away (e.g. in a direction substantially parallel to the length of the stretcher) from the end of the stretcher, wherein, when the handle is moved from the stored position to the deployed position the handle does not extend beyond the sides of the stretcher.

The stretcher of fourth aspect may have any one or more of the features, in including the preferable features, of the first, second or third aspects.

The floor of the ambulance may be modified to help with the loading and unloading of the ambulance. For example, the ambulance may comprise rails which receive loading wheels of the patient support and of the base. The base may be received in the portion between the rails. In this circumstance the loading wheels may be provided more outwardly in the width direction than the base wheels. This is so the loading wheels can be received on the rails whilst the base wheels are located between the rails.

Certain preferred embodiments of the present invention will now be described by way of example only with reference to the accompanying drawings, in which:

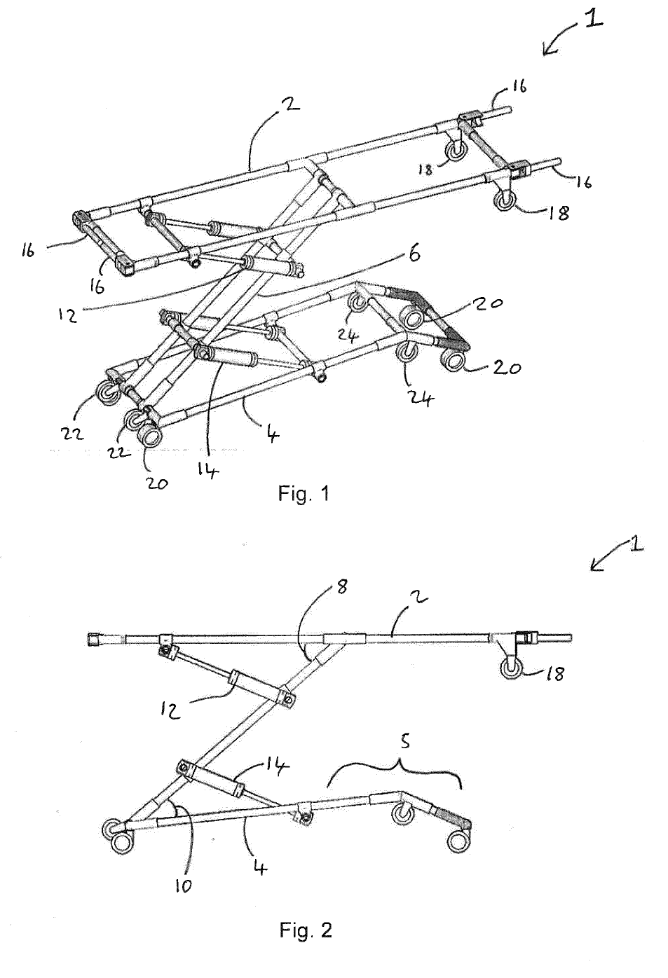

FIG. 1 is a perspective view of a stretcher;

FIG. 2 is a side view of the stretcher;

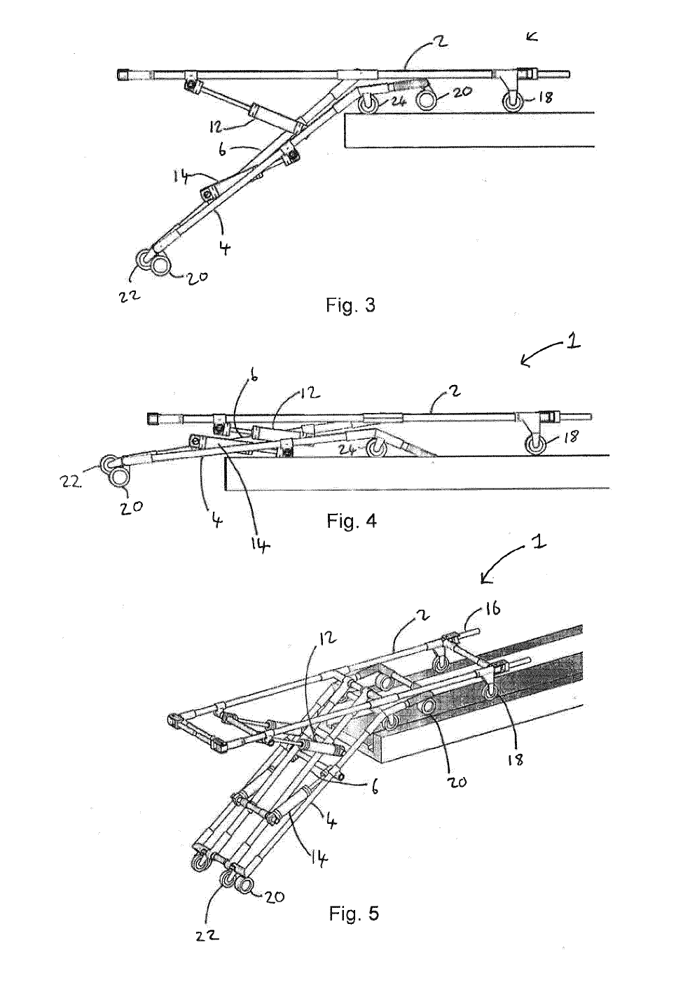

FIG. 3 is a side view of the stretcher during loading into or unloading from an ambulance;

FIG. 4 is a side view of the stretcher at a different stage of loading into or unloading from an ambulance;

FIG. 5 is a perspective view of the stretcher during loading into or unloading from an ambulance;

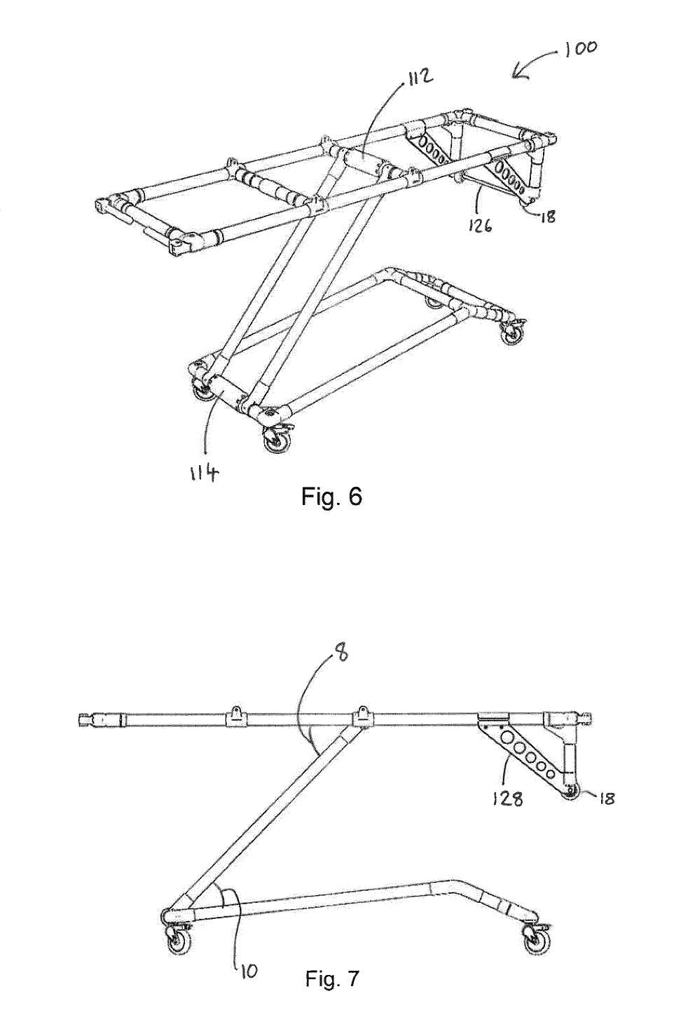

FIG. 6 is a perspective view of a second stretcher;

FIG. 7 is a side view of the second stretcher;

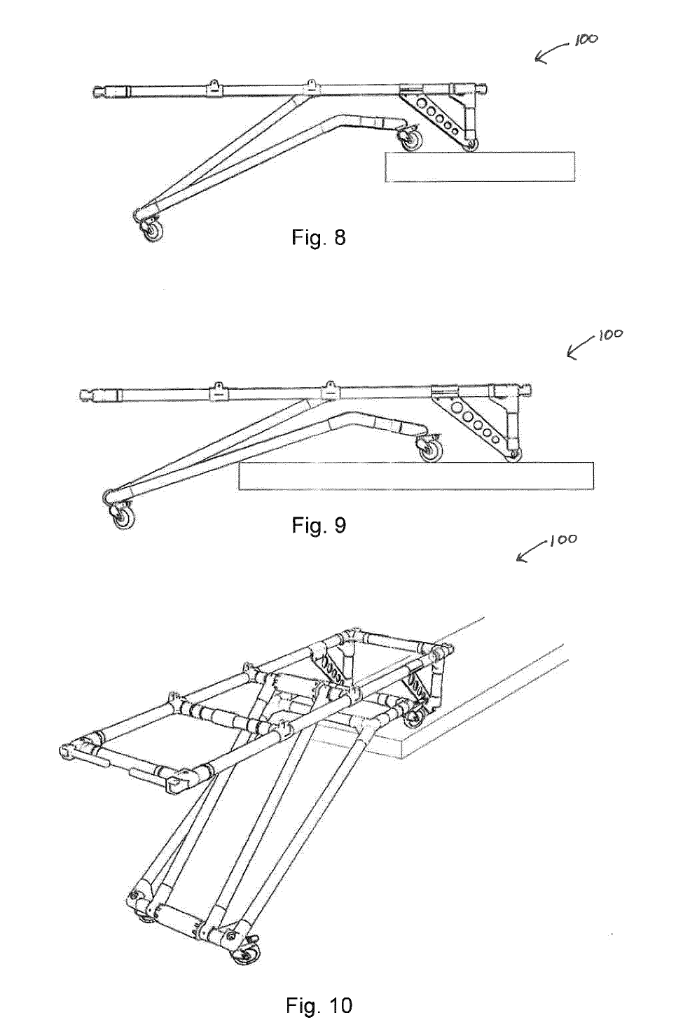

FIG. 8 is a side view of the second stretcher during loading into or unloading from an ambulance;

FIG. 9 is a side view of the second stretcher at a different stage of loading into or unloading from an ambulance;

FIG. 10 is a perspective view of the second stretcher during loading into or unloading from an ambulance;

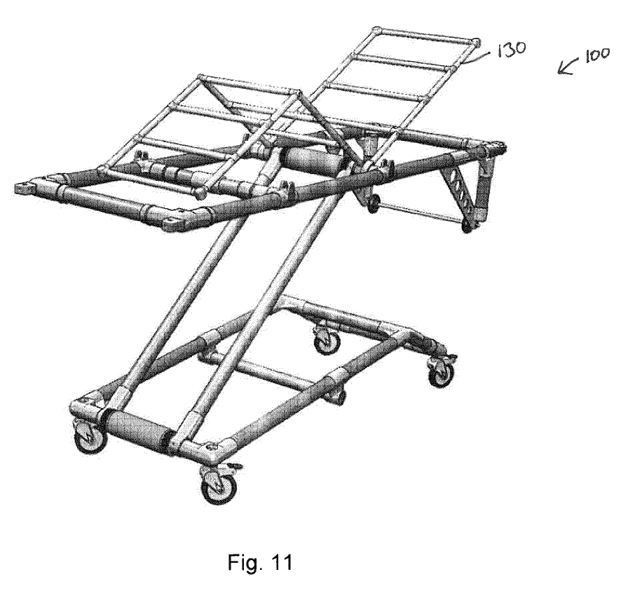

FIG. 11 is a perspective view of the second stretcher with a bed attached.

FIG. 1 shows a stretcher 1 which is used to facilitate the loading and unloading of a patient into or from an ambulance. The stretcher 1 comprises a patient support 2, a base 4 and a connection member 6. A bed 130 on which a patient will sit or lie in use may be provided on the patient support 2 (an example stretcher with the bed 130 is shown in FIG. 11).

The base 4 may have an angled or raised portion 5 as shown most clearly in FIG. 2 which facilitates loading and unloading the stretcher into or from an ambulance (as shown for example in FIGS. 3 and 5).

The connection member 6 is pivotally connected at one end to the patient support 6 to form a first angle 8 and pivotally connected at the other end to a base 4 to form a second angle 10. The connections are such that the patient support 2, the connection member 6 and the base 4 can form a Z shape as shown in FIGS. 1 and 2.

The first angle 8 can be controlled using a first angle adjustment device, actuator 12 and the second angle 10 can be controlled using a second angle adjustment device, actuator 14. The first actuator 12 and the second actuator 14 may be operated independently so that the size of first angle 8 and the size of second angle 10 can be controlled and set independently. The first angle 8 may be adjusted without adjusting the second angle 10 and the second angle 10 may be adjusted without adjusting the first angle 8.

In normal operation the stretcher 1 may assume the position shown in FIGS. 1 and 2 in which the base 4 and the patient support 2 are substantially parallel to each other and located a distance from each other (for example between 0.5 and 1.5 m depending on the height it is desired to have the patient).

The stretcher 1 may comprise one or more handles 16. The handles 16 are pivotally connected to the patient support 2 and may be moved between a stowed position as shown on the left-hand side of FIG. 1 and a deployed position as shown on the right-hand side of FIG. 1 as desired. The handles 16 are arranged so that when they are moved between the stowed position and deployed position, or vice versa, they never extend beyond the sides of the stretcher 1. This is so that the handles 16 can be deployed and stowed even when the stretcher is in a narrow space.

The patient support 2 comprises two loading wheels 18 near one end. This is the end that will be first loaded into an ambulance in use as described in more detail below.

The base 4 comprises four base wheels 20. These wheels 20 are the wheels which will be in contact with the ground during normal wheeling operation of the stretcher. The base 4 also comprises two support wheels 22. These are the wheels which may be in contact with the ground during loading or unloading of the stretcher 1 from an ambulance. The base 4 may also comprise two base loading wheels 24. These are the wheels which may be in contact with the floor of the ambulance during loading or unloading of the stretcher 1.

When it is desired to load the stretcher 1 into an ambulance first the height of the patient support 2 may be adjusted so that it is at the correct height to be wheeled into the ambulance. This is achieved by adjusting both the angles 8 and 10 simultaneously using the actuators 12, 14 to increase or decrease the angles to adjust the height of the patient support 2.

Once the patient support 2 is at the desired height the first end of the patient support 2 can be wheeled into the back of the ambulance so that the loading wheels 18 are received on the surface of the ambulance to which the stretcher is to be loaded.

The second actuator 14 may then be operated to reduce the second angle 10 so that one end (the end to be loaded into the ambulance first) of the base 4 moves towards the patient support 2 until it is in the position shown in FIG. 3. The stretcher 1 may then be pushed further into the ambulance and the base loading wheels 24 are received on the floor of the ambulance. At this point, part of the weight of the stretcher 1 will be supported by the support wheels 22 or base wheels 20 which are at the end of the base 4 which is not yet loaded into the ambulance.

The stretcher 1 may then be pushed into the ambulance until at least 50% of the weight of the stretcher 1 (and patient if present) is in the ambulance. The first actuator 12 may then be operated to reduce the first angle 8 until the base 4 is located near and substantially parallel to the patient support 2 as shown in FIG. 4.

The stretcher 1 may then be pushed entirely into the ambulance.

The unloading of the stretcher 1 from the ambulance may be the opposite of the loading method described above.

The floor of the ambulance may be provided with rails as shown most clearly in FIG. 5 which facilitates the loading and unloading of the present stretcher 1. The patient support loading wheels 18 and the base loading wheels 24 may be positioned on the stretcher to be received on the rails as shown in FIG. 5 whilst the base wheels 20 may be received between the rails.

FIGS. 6 to 11 show another stretcher. Features of this second stretcher 100 which are the same as the first stretcher 1 shown in FIGS. 1 to 5 will not be described again. Instead, the main features which are different in this second stretcher 100 will be described.

The second stretcher 100 has a first angle adjustment device 112 and a second angle adjustment device 114 which are each a separate motor. As with the first stretcher the first angle adjustment device 112 and a second angle adjustment device 114 may be operated independently so that the size of first angle 8 and the size of second angle 10 can be controlled and set independently.

Each motor 112, 114, is coaxial with the axis of the respective pivotal connection. Each motor may control the pivotal connection so as to adjust the respective angle.

The second stretcher 100 comprises a cross bar 126 which extends between and connects the pair of loading wheels 18 provided at one end of the patient support. Further, each loading wheel is supported by an oblique (oblique relative to the patient support) support bar 128. This may increase the strength of the loading wheels.

I claim:

1. A stretcher, the stretcher comprising:
a patient support;
a base;
a connection member, the connection member being pivotally connected to the patient support and pivotally connected to the base such that the patient support, the base and the connection member can form a Z-shape with a first angle at the corner of the Z-shape between the patient support and the connection member and a second angle at the other corner of the Z between the base and the connection member;
a first angle adjustment device for controlling the first angle; and
a second angle adjustment device for controlling the second angle,
wherein the first angle adjustment device and the second angle adjustment device can be operated independently of each other so that the first angle and second angle can be controlled independently.

2. A stretcher according to claim 1, wherein the stretcher is movable into a first position in which the patient support and the base are substantially parallel to each other and separated from each other to form the Z shape with the connection member.

3. A stretcher according to claim 2, wherein the stretcher is movable into a second position in which the base and patient support are angled relative to each other.

4. A stretcher according to claim 3, wherein in the second position the base is in a position so that during loading of the stretcher into an ambulance it can at one end be in contact with the floor of an ambulance and at the other opposite end be in contact with the surface from which the stretcher is being loaded.

5. A stretcher according to claim 3, wherein the stretcher comprises a support wheel, wherein the support wheel is arranged so as to be in contact with the ground when the stretcher is in the second position and is being loaded into an ambulance.

6. A stretcher according to claim 3, wherein the stretcher is movable into a third position in which the patient support and the base are substantially parallel to each other and in close proximity to other.

7. A stretcher according to any preceding claim 1, wherein the pivotal connection between the connection member and the patient support is in a fixed position relative to the patient support and/or wherein the pivotal connection between the connection member and the base is in a fixed position relative to the base.

8. A stretcher according to claim 1, wherein the patient support comprises one or more loading wheels that are located on the underside of the patient support.

9. A stretcher according to claim 1, wherein the length of the base is shorter than the length of the patient support.

10. A stretcher according to claim 1, wherein the base is shaped so that when one end of the base is in contact with the floor of the ambulance and the other end of the base is in contact with the ground from which the stretcher is being loaded, the stretcher can be pushed into the ambulance so that at least 50% of the weight of the stretcher can be inside the ambulance before the back edge of the ambulance floor meets the underside of the base.

11. A stretcher according to claim 1, wherein the first angle adjustment device is an actuators that is arranged so as to be able to control and hold a certain angle between the patient support and the connection member and the second angle adjustment device is an actuator that is arranged so as to be able to control and hold a certain angle between the base and the connection member.

12. A stretcher according to claim 11, wherein the actuators use pressurised air as a propellant.

13. A method of loading a stretcher into an ambulance, the method comprising:
providing a stretcher comprising:
a patient support;
a base; and
a connection member, the connection member being pivotally connected to the patient support and pivotally connected to the base such that the patient support, the base and the connection member can form a Z-shape with a first angle at the corner of the Z-shape between the patient support and the connection member and a second angle at the other corner of the Z between the base and the connection member;
loading one end of the patient support into the ambulance;
adjusting one of the angles so that the base is angled relative to the patient support;
loading a first end of the base into the ambulance whilst a second end of the base is in contact with the ground;
moving the stretcher further into the ambulance;
adjusting the other angle so that the base is substantially parallel to the patient support; and
moving the stretcher entirely into the ambulance.

14. A method of unloading a stretcher from an ambulance, the method comprising
providing a stretcher comprising:
a patient support;
a base; and
a connection member, the connection member being pivotally connected to the patient support and pivotally connected to the base such that the patient support, the base and the connection member can form a Z-shape with a first angle at the corner of the Z-shape between the patient support and the connection member and a second angle at the other corner of the Z between the base and the connection member;
moving the stretcher so that it is partially out of the ambulance;
adjusting one of the angles so that the base is angled relative to the patient support so that one end of the base is in contact with the ground whilst the other end is in contact with the floor of the ambulance;
moving the stretcher further out of the ambulance until the base is no longer in contact with the floor of the ambulance;
adjusting the other of the angles so that the base is substantially parallel to the patient support and in contact at each end with the ground; and
moving the stretcher entirely out of the ambulance.

15. A stretcher according to claim 1, further comprising a handle that is pivotally connected to the stretcher, the handle being movable between a stored position in which the handle is substantially parallel to the end of the stretcher and a deployed position in which the handle extends away from the end of the stretcher, wherein, when the handle is moved from the stored position to the deployed position the handle does not extend beyond the side of the stretcher.
